(19) United States
(12) Patent Application Publication
(10) Pub. No.: US 2013/0055604 A1
(43) Pub. Date: Mar. 7, 2013

(54) COLLAPSIBLE DISPLAY STRUCTURE

(71) Applicants: Bernardo Herman Baran, Tlalnepantla (MX); Mauricio Herman Dantus, Tlalnepantla (MX); Roman de Jesus Chavez Herrera, Tlalnepantla (MX); Mauricio Ricardo Benito Alvarez Cedeño, Tlalnepantla (MX); Agustin Cervantes Malagon, Tlalnepantla (MX); Enrique Guzman Barraza, Tlalnepantla (MX)

(72) Inventors: Bernardo Herman Baran, Tlalnepantla (MX); Mauricio Herman Dantus, Tlalnepantla (MX); Roman de Jesus Chavez Herrera, Tlalnepantla (MX); Mauricio Ricardo Benito Alvarez Cedeño, Tlalnepantla (MX); Agustin Cervantes Malagon, Tlalnepantla (MX); Enrique Guzman Barraza, Tlalnepantla (MX)

(21) Appl. No.: 13/581,116

(22) PCT Filed: Feb. 26, 2011
(86) PCT No.: PCT/IB11/00408

§ 371 Date: Nov. 13, 2012

Related U.S. Application Data
(60) Provisional application No. 61/308,353, filed on Feb. 26, 2010.
(60) Provisional application No. 61/406,692, filed on Oct. 26, 2010.

(51) Int. Cl. A47F 5/10; A47F 5/11; G09F 7/00; A47F 3/14

(52) U.S. Cl. 40/606.03; 211/133.1; 211/126.14

(57) ABSTRACT

A telescopic display structure is disclosed, the structure having a number of columns each having two or more substantially hollow parts, each part having two ends, a first part having a first width and an opening proximate to an upper end and a second part having a second width and an opening proximate to a lower end, the two widths of the two parts being different, so that at least part of the second part may slide within the first part, the grooves or openings having the same direction in regards to the display structure and being co-lineal when the telescopic display structure is in an extended position. A tray base having faces is fixed to the column. A resilient device having resilient parts is placed within the lower end of the second part of the columns, one the parts of the resilient device having a protuberance with the same direction as the openings and with a length such that said protuberance passes through the openings of the parts of the column when the protuberance is co-lineal with said openings and when the telescopic display structure is in an extended position.

### CROSS-REFERENCE TO RELATED APPLICATIONS

This application claims benefit of provisional applications Nos. 61/308,353 filed on Feb. 26, 2010 and 61/406,692 filed on Oct. 26, 2010.

### FIELD OF THE INVENTION

The present invention refers to product displaying structures, and more specifically to collapsible displays which may be assembled and disassembled for the display of products in a point of sale, and even more specifically to collapsible and telescopic product displays with at least one tray to carry and display products at the point of sale, and an assembly and disassembly method of these displays.

### BACKGROUND

The constant population growth demands a production of large volumes of products to be purchased. In the points of sale, structures that make it possible to carry a large volume of products in reduced space is required, without missing the primary detail of displaying the product are needed. The distributors of consumable products have problems when setting up a display quickly and completely in the less time possible, and also dealing with the display having the adequate capacity to carry and display the consumable products that are being displayed.

Producers try to solve these problems sending their products packed in a structure that is capable of transporting and displaying the products. While this is Useful for certain products, there are other products that have to be set up in situ due to the kind of product or to the producer's preference. There are several publications of products that are assembled in situ. One of the desires when assembling in situ is that the displays be easily and quickly assembled, so that the user assembling the displays may mount his display stand as quick as possible, so as to let consumers begin viewing and/or purchasing the product.

Chinese publication No. 101814258 discloses a display Module with adjustable size, comprising at least one group of spacing adjustment mechanism. The spacing adjustment mechanism is a telescopic fence like structure or a grid telescopic fence like structure, thus the spacing adjustment mechanism can cause the display module to be in different size modes after compression or stretching adjustment.

US publication No. 2006086867 discloses a telescopic display stand includes a base and a fixed tube secured on the base. At least one tube is telescopically received in the fixed tube. A sleeve is rotatably received in the first tube and has an axle mounted at a bottom of the sleeve. At least one threaded rod is threadingly received in the sleeve and has a top end fastened at a top end of the at least one tube. A drive unit is mounted in the base and connected to the axle. An effigy sheath is mountable over the tube. Whereby, the display stand can be automatically erected for use and retracted for storage.

Chinese publication No. 2687776 discloses an advertisement display device with an upper beam and a lower beam, wherein, a telescopic rack and a rolling belt used for sticking an advertisement are connected between the upper beam and the lower beam; the upper beam is provided with two beam seats, two telescopic rack mounting seats, two shaft sleeves, a sliding shaft, and a motor. The lower beam is provided with two beam seats and a regulating shaft. When the utility model is used, firstly, the regulating shaft can be rotated to make the spacing of the two beam seats of the upper beam be corresponding to the spacing of the two beam seats of the lower beam.

European publication No. 1 510 157 discloses a display showcase comprising a base for a bell-jar, a bell-jar, suitable for defining, together with the base, a display space with respect to an external environment, an opening device for the showcase by vertical translation of the bell-jar with respect to the base. The opening device comprises at least two lifting groups, each comprising at least three coaxial telescopic elements actuated through a screw mechanism.

Japanese publication No. 10174638 discloses a display case with a frame-shaped upper rack and a lower rack and the outer circumference size of the upper rack is made smaller than the inner circumference size of the lower rack. A stopper material is protrusively arranged near a bottom plate of the upper rack to surround an outside surface thereof. When the upper rack is stacked on the lower rack, the stopper material is held at a position of entirely contacting the upper rim part of the lower rack part to allow use as double stage rack. The upper and lower racks are made detachable to keep the upper rack isolated from the lower rack turned upside down thereby allowing the housing of the upper rack into the lower rack in a telescopic manner.

### BRIEF DESCRIPTION OF THE INVENTION

The present invention refers to collapsible structures for displaying products. Specifically, the present invention refers to vertically collapsible displaying structures with telescopic columns.

The structure may take any geometric form, such as polyhedron of any kind, for instance, a tetrahedron, pentahedron, hexahedron, octahedron, dodehedron, icosahedrons, icosidohedron, icosidodecahedron, rhombic triacontahedron, elongated pentagonal domes, octagonal prisms, deltrahedron, stellar polyhedron and zonohedrons, among others; wherein the tetrahedrons, pentahedrons, hexahedrons and octahedrons may be preferred; the geometric forms also include cylindrical forms. The material from which the display is made of may vary, yet strong materials that do not easily bend, but still have certain flexibility are preferred. Such materials are plastics like Polystyrenes, PVC, high density polystyrenes, polypropylenes, PET, etc., wood, metals that tend to have certain flexibility such as aluminum; cardboard, corrugated cardboard, etc.

The columns of the collapsible structure vary in width. This is preferred so that at least one part of the column may be nested within a second part of the column and hence the column may be telescopic. It is preferred that the lower part of the column is wider than the upper part of the same column, so that the structure has a greater stability and balance once the products to be displayed are being supported by the structure. Once the structure is in its place to display, the columns are telescopically extended from their nesting position. The columns are fixed to their extended position by grooves or openings and by protuberances. That is, as stated before, there are several parts to the column; specifically, there is at least one lower part and at least one upper part, the lower part may contain a groove or opening or a protuberance and the upper part may contain the opposite, that is, contain a protuberance if the lower part contained the groove or opening or a groove or opening if the lower part contained a protuberance, wherein the protuberance fits within the groove or opening, so that the upper part of the column, when sliding telescopically from the lower part of the column, has a stop. This relation between the lower column and the upper column will allow the upper column to carry weight in regards to the lower column. The grooves or openings may be located in different horizontal positions of the columns so that the plurality of grooves or openings may not be co-lineal in a Y axis. The tray base carries the tray in which the product to be displayed will be placed. The above location of the grooves or openings in different horizontal positions of the columns provides means so that the tray bases and trays may be in a slanted position.

All the tray bases may include at least one substantially horizontal face, although at least two joined faces which are substantially perpendicular are preferred, wherein there is a substantially horizontal face and a substantially vertical face. At least one face is joined directly or indirectly to the column by fastening means.

Holding and fastening devices may be provided throughout the telescopic columns. Specifically, the holding and fastening devices are divided into two essential parts, a first part which is a fastening part, in which an opening is provided, the opening crossing the entire height of the holding and fastening device, opening through which an upper end of a telescopic column part will be inserted and by which the upper end of the telescopic column part will be fastened to the holding and fastening device. The opening will increase in size in regards to the part of the telescopic column to which it is to be attached. That is, if the holding and fastening device is to be placed in the uppermost part of the displaying structure, then the opening will correspond to the smallest opening in accordance with the telescopic column above-described, whereas if the holding and fastening device is to be placed in the lowermost part of the displaying structure, then the opening will correspond to the biggest opening in accordance with the telescopic column above-described. The second part of the holding and fastening device is a holding part, which will be placed in an inwardly direction in regards to the displaying structure. The holding part is able to support the tray; specifically, the holding part is able to support the tray by means of supporting the tray base. It is preferred that the holding part is substantially flat. Fastening means which hold together the tray base and holding and fastening device are fastened in the horizontal face of the tray base and the lateral wall of the fastening part.

As stated above, and since the columns have different widths the structure may be almost entirely collapsed. The lowest tray or first tray is preferably in a lower portion of the structure and more preferably proximate to the floor, where the column which supports the first tray remains standing in the same position, and wherein the column part which is between the second tray and the first tray is not collapsed. The column part which is between the third tray and the second tray is collapsed to be nested within the first column part, that is below the first tray and within the second column part, that is, between the first and second trays. The column part which is between the fourth tray and the third tray is collapsed to be nested within the first, second and third column part. This process is repeated depending on the number of trays and column parts. Since the column parts have different widths, and preferably, the lowest column part or first column part is preferably the widest of all the column parts, all the other column parts may be nested, at least partially, within this first column part. Likewise, the second column part or the second lowest column part is preferably the second widest of all the column parts, the second column part may receive, at least partially, other column parts which are not the first.

The columns are fixed or fastened when an extended position by grooves and protuberances in the columns. The groove may be an opening rather than a groove, and the term groove for this application should be interpreted as being either a groove or an opening. The groove, if in fact a groove rather than an opening, may be made of a flexible material or a material which has a certain resiliency so as to be pushed in an inward direction. A first groove is formed in the length of the column, near an end of a first column. A second groove is formed in the opposite end of the first column. The second groove having substantially the same direction as the first groove. In the inner part of the lower part of a determined section of the telescopic column, a closure is inserted. Each determined section of the column has a closure. The closure is made from two different sections, a first section having a first width and a second section having a second width. The second section is substantially flat, and has a width which is substantially similar or larger than the width of the lower part of a determined section of the telescopic column, so that when the closure is inserted within the walls of the telescopic column, the second section abuts with the lower end of the determined section of the telescopic column. The first section, which is less wide than the second section and has a height which is substantially greater than the height of the second section, is inserted within the lower end of the determined section of the column. The first section is made up of three different walls, wherein the three walls substantially form a “U” section, wherein the “U” section may be replaced for a two-walled “V” section, wherein the three walls may have substantially 90° edges or less, hence forming right-angle edges or edges being more obtuse, wherein a first horizontal wall has in its upper-part a furrow and a second horizontal wall has in its upper part an aperture which crosses the width of the second horizontal wall. An elastic or resilient device, such as a spring, which is essentially made from at least two parts, a first part which abuts with a first end the furrow of the first horizontal wall, and a second end of the first part is adjoined with the a first end of the second part, and wherein the second end of the second part has a protuberance, such as a bolt or pin, which crosses the second horizontal wall of the first section through its aperture. The protuberance of the elastic or resilient device should have such a length that it is able to extend across not only the aperture of the of the second horizontal wall, but also to extend across the first groove formed in the length of the column section and a second groove formed in the opposite end of a further column section. Therefore, the protuberance may be pushed by a user in an inward direction in regards to the column so as to slide the telescopic column and so as to collapse the column. Furthermore, when sliding the telescopic column so as to extend the column, the elastic or resilient must have the sufficient force to push the protuberance in an outwards direction when the first and second grooves of different columns are co-lineal with each other, hence fastening in a determined position a first column with a second column.

The upper-most holding and fastening device may leave an opening, hence the inner part of the column is accessible. This opening may allow the insertion of a publicity top, hence the publicity top may remain fixed to the displaying structure by means of the column.

The tray base may have a cover which is set in place by means of the tray and the tray base. The cover will cover at least the outer faces of the tray base. The cover may cover all the outer faces of the tray base and at least one inner face of the tray base. To provide such a cover, the cover has to be made up of different parts which may be folded. As such, the cover may have at least two folding parts or four folding parts. Covers may help publicize a determined product, hence are likely to be changed if the product display is constantly re-used. So as to avoid waste, a cover may be devised in such a manner, that said cover is pressured by the lateral faces, as well as the lower fate or lateral face of the tray when the tray is inserted in its final resting place. When the tray is removed from its final resting place, and since the tray is no longer pressuring the cover, the cover may be removed from the tray base. The cover, in the part covering the inner side of the vertical face of the tray base, preferably has flanges which abut the horizontal face of the tray base. The flanges are pressured by the tray when the tray is in place. Likewise, flanges may be provided in the cover in the part covering the inner side of the horizontal face of the tray base. These second flanges may laterally abut the first flanges above disclosed. The second flanges may be fastened with the first flanges so as to provide a fastening means for the cover in regards to the tray base.

The structure may have wheels so that it may be easily moved. Alternately, the structure may have rubber structures in the lowest part to provide a better grip with the floor.

### BRIEF DESCRIPTION OF THE FIGURES

FIG. 1 is a conventional perspective view of the product displaying structure with telescopic columns.

FIG. 2 is an upper view of the product displaying structure.

FIG. 3 is a front view of the structure.

FIG. 4 is a side view of the product displaying structure.

FIG. 5 is a conventional perspective view of the product displaying structure when collapsed. The arrows show the direction to collapse the structure.

FIG. 5A is a detailed view of FIG. 5.

FIG. 6 is an exploded view of some of the parts forming the collapsible structure.

FIG. 7 is a conventional perspective view of the product displaying structure being expanded. The arrows show the direction to extend the structure.

FIG. 8 is a conventional perspective view of a tray base for the product displaying structure, and the relation between the tray base and the holding and fastening device.

FIG. 9 is a cross-section view of the tray, tray base and cover along lines A-A′ of FIG. 8.

FIG. 10 is a conventional perspective view of the tray, the tray base and the cover.

FIG. 11 is a conventional perspective view of the product displaying structure with a closure being placed within a lower end of part of the telescopic structure.

FIG. 11A is a detailed view seen from an upper conventional perspective of FIG. 11.

FIG. 11B is a detailed view seen from a lower conventional perspective of FIG. 11.

FIG. 12 is a conventional perspective view of the product display with a closure placed on one of the lower ends of the columns.

FIG. 12A is a detailed view of FIG. 12.

FIG. 13 is a conventional perspective view of the closure.

FIG. 14 is a lateral view of the closure.

FIG. 15 is a front view of the closure.

FIG. 16 is an exploded conventional perspective view of part of the product display structure and an advertising top.

FIG. 17 is an conventional perspective view of part of the product display structure and an advertising top.

FIG. 18 is an upper view of the upper-most holding and fastening device.

FIG. 19 is an upper view of the second upper-most holding and fastening device.

FIG. 20 is an upper view of the third upper-most holding and fastening device.

FIG. 21 is an upper view of the lowest holding and fastening device.

FIG. 22 is a lower view of the lowest holding and fastening device.

FIG. 23 is a conventional perspective view of first embodiment of the invention.

FIG. 23a is a cross-section view along the a-a′ lines of FIG. 23.

FIG. 23b is a cross-section view along the b-b′ lines of FIG. 23.

FIG. 23c is a cross-section view along the c-c′ lines of FIG. 23.

FIG. 23d is a cross-section view along the d-d′ lines of FIG. 23.

FIG. 23e is a top view of a column of the first embodiment when in a retracted position.

FIG. 24 is an exploded view in conventional perspective of the first embodiment of the invention.

FIG. 24a is a first detail view of FIG. 24.

FIG. 24b is a second detail view of FIG. 24.

### DESCRIPTION OF THE INVENTION

### Definitions

The term “groove” in the present application may refer to a groove as known in the art, that is, a channel or depression or may also refer to an opening.

The term “fastening means” may refer to any fastening means available in the art, such as bolts, screws, snaps, adhesives, materials with adhesives or different types of welding, among others.

The present invention refers to collapsible structures for displaying products. Specifically, the present invention refers to vertically collapsible and extendible displaying structures 2 with telescopic columns 20. The height of the displaying structures 2 is composed of at least three telescopic columns. The number of telescopic columns is related to the geometric form the structure 2 has.

The structure 2 may take any geometric form, such as polyhedron of: any kind, for instance, a tetrahedron, pentahedron, hexahedron, octahedron, dodehedron, icosahedrons, icosidohedron, icosidodecahedron, rhombic triacontahedron, elongated pentagonal domes, octagonal prisms, deltrahedron, stellar polyhedron and zonohedrons, among others, wherein the tetrahedrons, pentahedrons, hexahedrons and octahedrons may be preferred; the geometric forms also include cylindrical forms. The material from which the display is made of may vary, yet strong materials that do not easily bend, but still have certain flexibility are preferred. Such materials are plastics like polystyrenes; PVC, high density polystyrenes, polypropylenes, PET, etc., wood, metals that tend to have certain flexibility such as aluminum, cardboard, corrugated cardboard, etc.

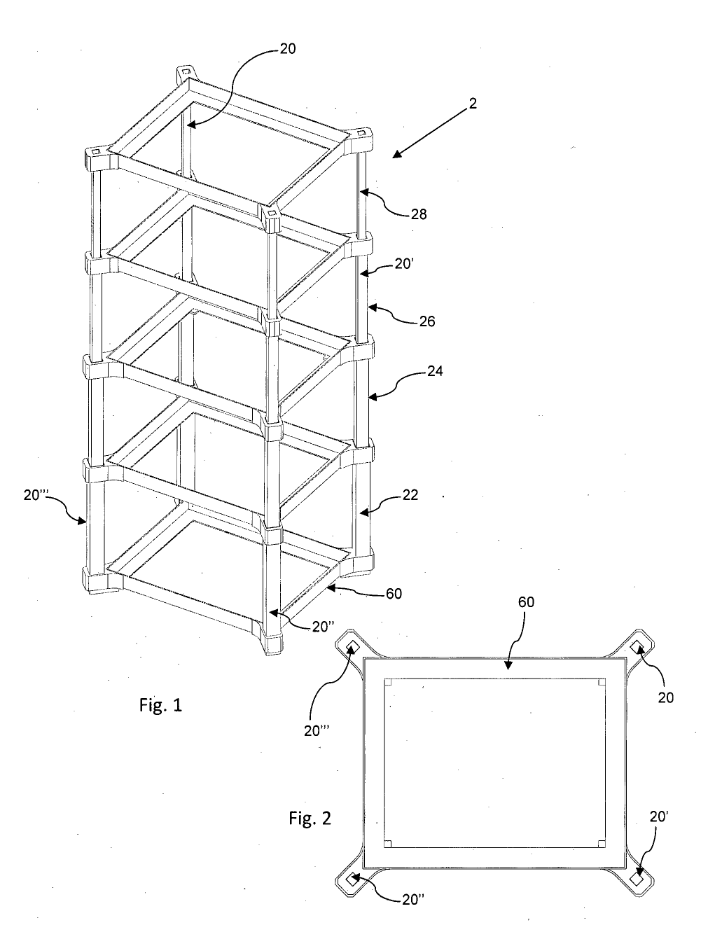

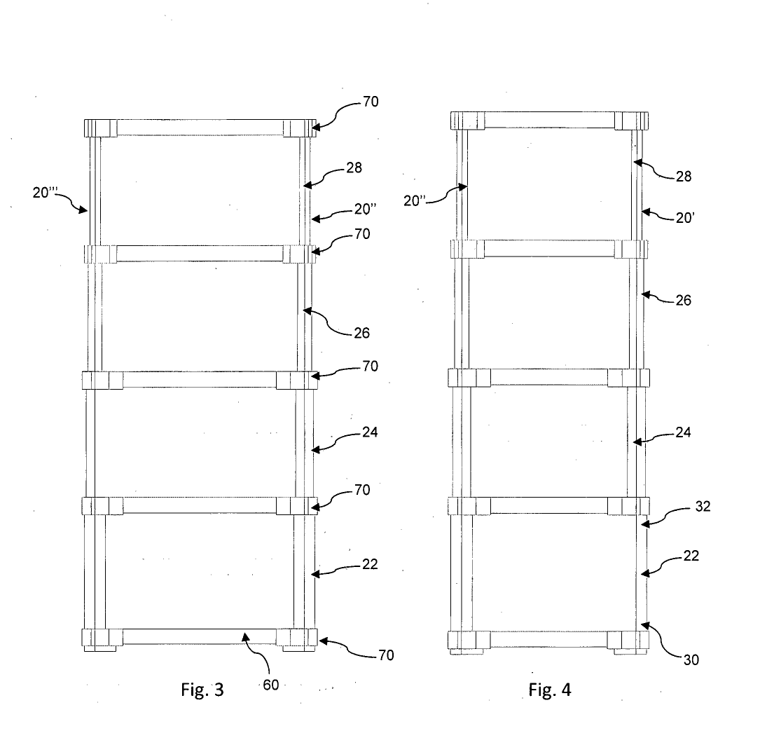

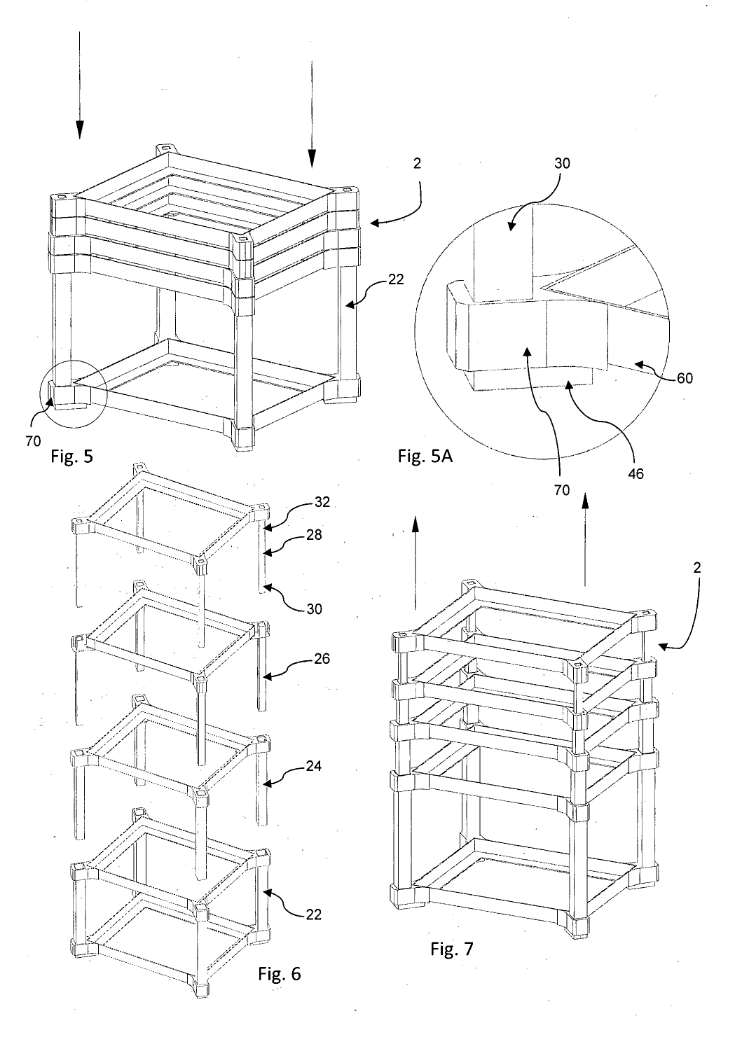

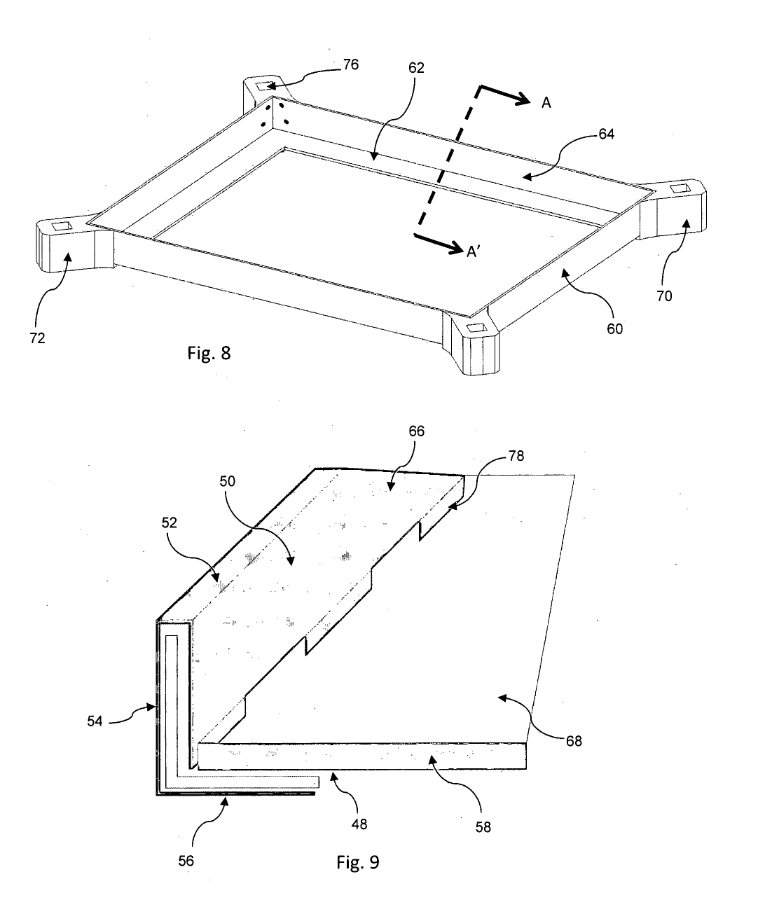

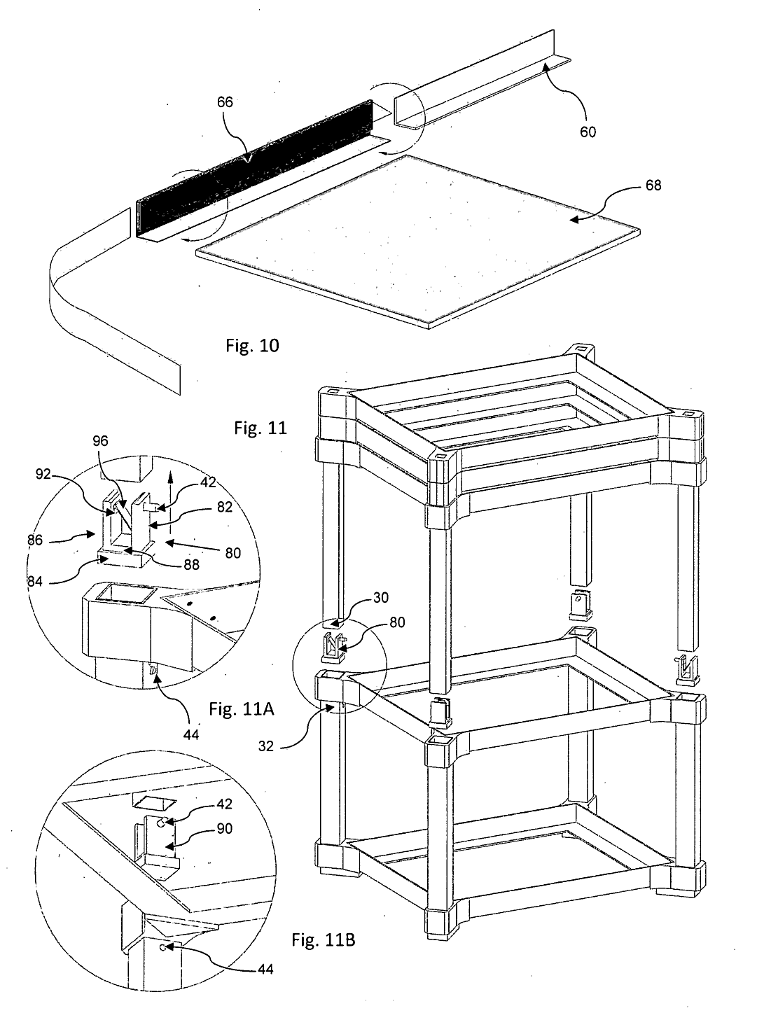

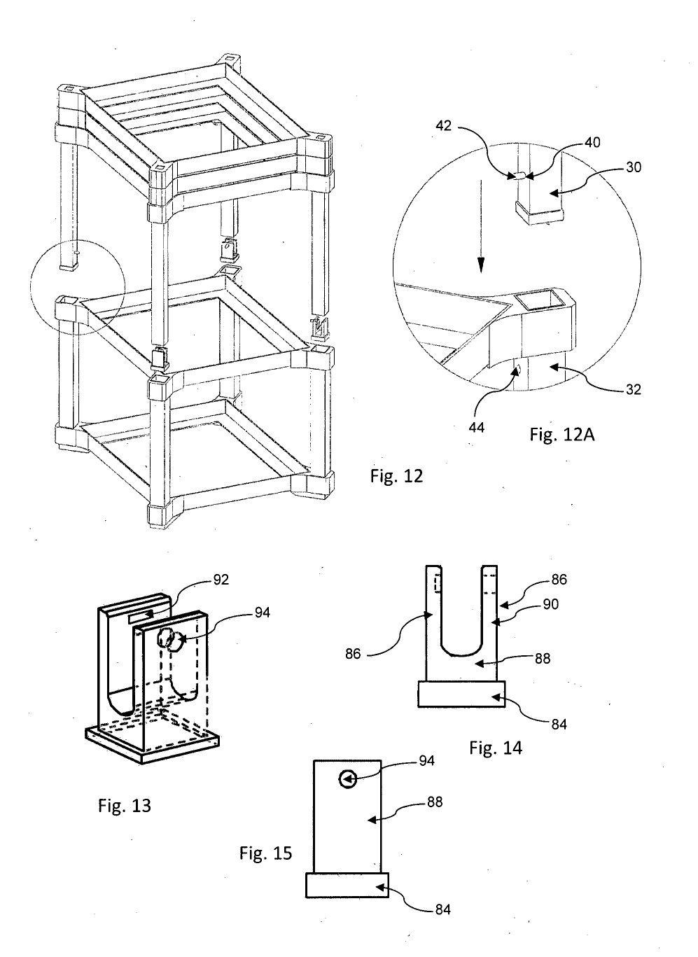

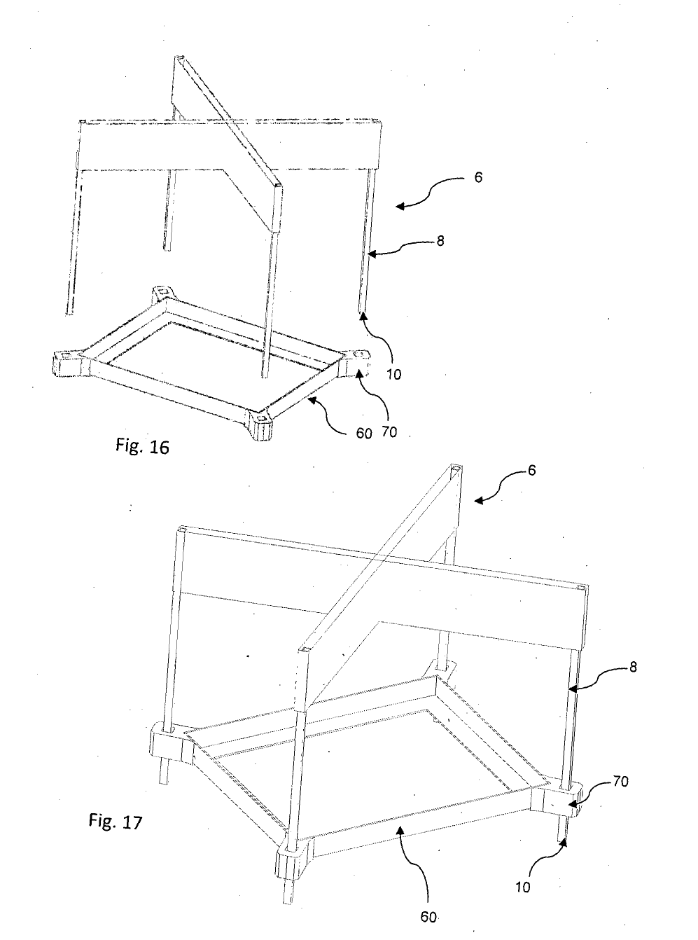

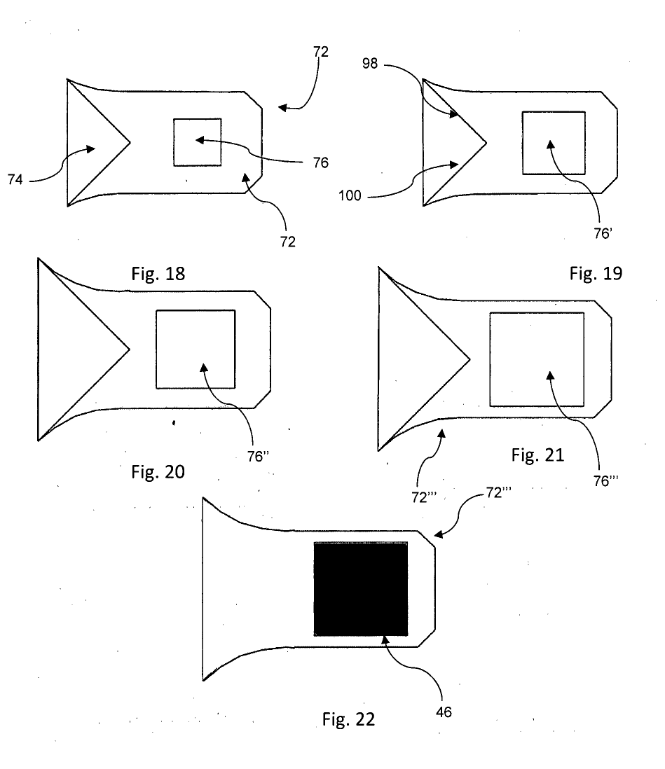

The following description is made in reference to FIGS. 1-22. The columns 20, 20′, 20″, 20″′ of the collapsible structure are made from different parts 22, 24, 26, 28, parts which vary in width. That is, it is preferred that the lower part 24 of the column is wider than the upper part 28 of the same column 20, so that at least a part of the upper parts 24, 26, 28 of the column may be nested within a lower part 22, 24, 26 of the column and hence the column 20 may be telescopic. Therefore, given the above, the columns 20 should be generally hollow. It is preferred that the lower part 22 of the column is the Widest, so that the structure 2 has a greater stability and balance once the products to be displayed are placed within the, structure 2. Once the structure 2 is in its place to display, the columns are telescopically extended from their nested position. The upper part 28 of the column, when extended, is fixed in position in regards to the third part 26 of the column by grooves 40 and by protuberances 42. That is, there are several parts 22-28 to the column; specifically, there is at least one lower part 22 and at least one upper part 28. If for example, only two parts 22, 28 are available, the lower end 30 of the upper part 28 contains a first groove 40 and a protuberance 42 and the upper end 32 the lower part 22 contains a second groove 44, the protuberance 42 being able to fit within the first 40 and second grooves 44, so that the upper part 28 of the column, when being extended and sliding telescopically away from the lower part 28 of the column stops when the protuberance 42 finds the second groove 44 and more specifically, when said protuberance 42 is inserted through said second groove 44; therefore, the first 40 and second groove 44 are co-lineal and crossed by the protuberance 42 when in an extended position. Therefore, if there are more than two parts a same part 22-28 may contain at least one groove or at least two grooves, a groove in the upper end 32 and a groove in the lower end 30. However, the same part may contain a plurality of grooves to provide different vertical positions of the part in regards to the display 2. This relation between the lower part 22 and the upper part 28 of the column will not only fix the two parts 22, 28 of the column, but will also allow the upper part 28 of the column to carry weight in regards to the lower part 22 when in an extended position. Given that there may be multiple grooves 40, 44 located in different vertical positions of the same parts 22-28 each protuberance 42 may provide a slanted tray; that is, the plurality of grooves in one determined part 22 of a first column 20 may not be co-lineal with the plurality of grooves in the same determined part 22 of a second column 20′. The tray base 60 carries the tray 4 in which the product to be displayed will be placed. The lack of co-lineality between the plurality of grooves between the same parts 22 of different columns 20, 20′ provides that the tray bases 60 and trays 4 may be in a slanted position.

All the tray bases 60 may include at least one substantially horizontal face 62, although at least two joined faces which are substantially perpendicular to each other are preferred, wherein there is a substantially horizontal face 62 and a substantially vertical face 64. At least one face is joined directly or indirectly, preferably indirectly to the column by holding and fastening devices 70. The vertex formed between the at least two faces 62, 64 is preferably placed in an inwards direction in regards to the structure 2.

Holding and fastening devices 70 may be provided in at least one end 30, 32 of the telescopic parts 22-28 of the columns 20. The holding and fastening devices 70 are fastened to the at least one end 30, 32 of the parts 22-28 of the column 20, however do not obstruct the openings 40, of the parts 22-28. Specifically, the holding and fastening devices 70 are divided into two essential parts, a first part which is a fastening part 72, in which an opening 76 is provided, the opening 76 crossing the entire height of the holding and fastening device 70, more specifically, the opening 76 crossing the entire height of the fastening part 72. The telescopic column 20, and more specifically, the ends 30, 32 of the corresponding parts 22-28 of the column will be inserted through said opening 76. The opening 76 increases in size in regards to the part 22-28 of the telescopic column 20 to which it is to be attached. That is, if the holding and fastening device 70 is to be placed in the uppermost part 28 of the display structure 2 then the opening 76 will correspond to the smallest opening 76, so that the upper end 32 of the uppermost part 28 can be slid into said opening 76 and fixed to said holding and fastening device 70 through said opening 76. The second uppermost holding and fastening device 70′ will contain an opening 76′, wherein the opening 76′ will be of larger size than the opening 76 of the holding and fastening device 70 the upper end of the uppermost part 28, so that the opening 76′ surrounds the upper end of the second uppermost part 26 and so that the second uppermost holding and fastening device 70′ is fastened to the upper end of the second uppermost part 26 without obstructing the upper opening of the second uppermost part 26 and so that the first part 24 can be slid into the second part 26 and through said opening 76′. The above is repeated until fixing the lowest holding and fastening device 70″′. The lowest holding and fastening device 70″′ is placed in the lower end 30 of the lowermost part 22 of the column, then the opening 76″″ in the upper part of the lowest holding and fastening device 70′″ will correspond to the biggest opening available; likewise, the second lowest holding and fastening device 70″ is slid and fixed to the upper end 32 of the lowest part 22 of the column, and will contain the biggest opening 76″″ available. In the lowest holding and fastening device 70″′, it is preferred that the opening 76″″ does not cross the height of the holding and fastening device 70″′. Furthermore, the fastening part may further be comprised of at least one wall and preferably two substantially perpendicular walls 78, 80 that abut the second part 74 of the holding and fastening device, wherein when the tray base 60 is placed in its resting position, one of the vertexes of the tray base 60 will be near to or abutting said substantially perpendicular walls 78, 80 so that said tray base 60 may be fixed, by conventional fixing means, to the holding and fastening device 70, and hence limiting the movement of the tray base 60. Specifically, the fastening means which hold together the tray base 60 and holding and fastening device 70 are fastened in the horizontal face 64 of the tray base 60 and the walls 78, 80 of the fastening part 72.

The second part of the holding and fastening device 70 is a holding part 74, which is placed in an inwardly direction in regards to the display structure 2. The holding part 74 is able to support the tray base 60; the tray base 60 may be fixed to the holding part by means of conventional fixing means, however is preferably only fixed to the fastening part 72 as above stated. Furthermore, and since the tray base 60 is fixed to the fastening part 72, then the holding part 74 is optional; however, providing the holding part 74 is preferred so than when heavy loads are placed in the display 2, the display may properly support the load. It is preferred that the fastening part 72 has a first height which is similar to the height of the substantially vertical face 64 of the tray base 60, while the holding part 74 is substantially flat, hence having a lesser height than the fastening part 72. Furthermore, it is preferred that the height of the fastening part 72 of the lowest holding and fastening device 70″′ is greater than that of the substantially vertical face 64 of the tray base 60 in a downwardly direction, so that a leg 46 may be left between the floor and the display 2.

As stated, since the columns 20, in view of different parts 22-28 having different widths throughout the height of said column 20, the structure 2 may be entirely collapsed. The lowest or first tray 68 is preferably in a lower portion of the structure 2 and more preferably proximate to the floor, where the lowest part 22 which supports the first tray 68 remains standing in the same position, that is the lowest part 22 which is between the second tray 68′ and the first tray 68 does not collapse. The column part 24 which is between the third tray 68″ and the second tray 68′, when collapsing the column, said part 24 is nested within the first column part 22, that is between the first tray 68 and the second tray 68′. The column part 26 which is between the fourth tray 68″′ and the third tray 68″, when collapsing the column, said part 26 is nested within the first and second column parts 22, 24. This process is repeated depending on the number of trays 68 and more specifically, the column parts 22-28.

Since the column parts 22-28 have different widths, and preferably, the lowest column part 22 or first column part is the widest of all the column parts 22-28, all the other column parts 24-28 may be nested, at least partially, within this first column part 22. Likewise, the second column part 24 or the second lowest column part is the second widest of all the column parts 22-28, the second column part 24 may receive, at least partially, other column parts 26, 28 which are not the first column part 22.

As stated above, the column parts 22-28 are put in place or fastened by grooves 40, 44 and protuberances 42 in the columns. As defined above, the groove 40, 44 may be an opening. rather than a groove. Preferably, the groove 40, 44 is an opening. The groove 40, 44, if in fact a groove rather than an opening, may be made of a flexible material or a material which has a certain resiliency so as to be pushed in an inward direction. A first groove 40 is formed in the length of the part 22-28, near one of the two ends of the part 22-28. A second groove 44 is formed in the opposite end of that same part 22-28. The second groove 44 has substantially the same direction than the first groove 40; the preferred direction of the grooves 40, 44 is generally inwardly bound with regards to the structure 2. Given that the parts 22-28 are preferably hollow, in the inner part of the lower end 30 of a part 24-28 of the column, a closure 80 is inserted. Each part 24-28, except for the lowest part 22 of the column has a closure 80 inserted in its lower end 30.

The closure 80 is essentially made from two different sections, a first section 82 having a first width and height and a second section 84 having a second width and height. The second section 84 is substantially flat, and has a width which is substantially similar or larger than the width of the lower end 30 of a part 28 of the column, so that when at least part of the closure 80 is inserted within the walls of the part 28, the second section abuts with the lower end 30 of the part 28 of the column and limits the inward movement of the closure 80 in regards to the part 28. The second section 84 supports the first section 82. The first section 82, which is less wide than the second section 84 and less wide than the lower end 30 of a part 28 of the column, has a height which is substantially greater than the height of the second section 84 and has a height which is capable of reaching the first groove 40 in the lower end 30 once the closure 80 is, at least in part, inserted in the lower end. Since the first section 82 is supported by the second section 84 and is of lesser width than the lower end 30 of the part 28, the first section 82 is inserted within the lower end 30 of the part 28 of the column. The first section 82 is made up of three different walls 86-90, wherein the three walls 86-90 substantially form a “U” section, wherein the “U” section may be replaced for a two-walled 86, 90 “V” section. The first wall 86 has a substantially vertical direction and is formed proximate to an edge of the second section 84, the second wall 88 is substantially perpendicular to the first wall 86 and is formed in the center of the second section 84 abutting with the first wall, and the third wall 90 has substantially the same direction than the first wall 86 and is formed near the opposite edge than the first wall 86 and abutting the second wall 88. Therefore, the three walls 86-90 may have substantially 90° edges or more, hence forming nearly right-angle edges or acute edges; this could depend upon the hollow form in the inner wall of the parts 22-28. The first wall 86 has proximate to its upper-part a furrow 92, the furrow 92 facing in a direction towards the third wall 90. The third wall 90 has in its upper part an aperture 94 which crosses the width of the third wall 90.

An elastic or resilient device 96, such as a spring, which is essentially made from at least two resilient or elastic parts substantially perpendicular between themselves, a first part having two ends and a second part having two ends, a first end of the first part abutting with the furrow 92 and a second end of the first part is adjoined with the a first end of the second part. The second part, proximate to its second end, has a protuberance 42, such as a pin, which crosses the aperture of the third wall 90. The protuberance 42 has a generally outwardly direction in regards to the closure 80. The protuberance 42 of the elastic device 96 has such a length that it is able to extend across the aperture 94 and both grooves 40, 44 formed in the parts 22-28 of the column and further have a length enough so that it may protrude from both grooves 40, 44 and may later be pushed in an inward direction by a user. The resiliency or elasticity of the device 96 is important since when pushed in an inwards direction by the user, the action of the resilient device 96 is to push in an outward direction the protuberance 42; likewise, when the grooves 40, 44 are not co-lineal the action of the resilient device 96 is to push in an outward direction the protuberance 42. Therefore, the protuberance 42 may be pushed in an inward direction in regards to the column 20 by a user, thus unlocking the parts 22-28 of the column and so as to slide the column 20 and so as to collapse the column 20. Furthermore, when sliding the column 20 so as to extend the column 20, the elastic or resilient device 96 must have the sufficient force to push the protuberance 42 in an outwards direction when the first and second grooves 40, 44 of different parts 22-28 are co-lineal with each other, hence fastening in a determined position the parts 22-28 of the column 20. Alternately, the closure 80 may be dispensed of, and the elastic device 96 may be comprised of essentially at least two resilient or elastic and substantially perpendicular parts as above disclosed, that is, a first part having two ends and a second part having two ends, a first end of the first part abutting with the inner wall of the part 22-28 of the column, a second end of the first part is adjoined with the a first end of the second part, and in the second part, proximate to the second end, has the protuberance 42.

The upper-most holding and fastening device 70 may leave an opening 76 in its upper part, hence the inner part of the hollow column part 28 is accessible. This opening 76 allows the insertion of a publicity top 6, hence the publicity top 6 may remain fixed to the display structure 2 by means of the columns 20-20′″ and posts 8 of the publicity top, and more specifically may remain fixed to the display structure 2 by means of the groove 44 in the column part 28 and a groove 40 proximate to the lower end 10 in the publicity top 6, as well as a closure 80 similar to that previously described for the column parts 22-28.

The tray base 60 may have a cover 66 which is set in place by means of the tray 68 and the tray base 60. The cover 66 will cover at least the outer faces of the tray base 60, that is the exterior side of the horizontal face 62 and the vertical face 64 will be covered by the cover 66. The cover 66 may cover all the exterior sides of the faces 62, 64 of the tray base and at least one inner side of the faces 62, 64 of the tray base. To provide such a cover 66, the cover 66 has to be made up of different parts 50, 52, 54, 56, the parts 50-56 being foldable between themselves. As such, the cover 66 may have at least two folding parts 54, 56 or preferably four folding parts 50-56. Covers 66 may help publicize a determined product and protect the tray bases 60, hence are likely to be changed if the product display 2 is constantly re-used. So as to avoid waste, a cover 66 may be devised in such a manner that said cover 66 is pressured by the lateral or end faces 58, as well as the lower face 48 of the tray 68 when the tray 68 is inserted in its final resting place. When the tray 68 is removed from its resting place in the display 2, and since the tray 68 is no longer pressuring the cover 66, the cover 66 may be removed from the tray base 60. The cover 66, in the part covering the inner side of the vertical face 64 of the tray base, preferably has flanges 78 which abut with the horizontal face 62 of the tray base, as well as with the lateral face 58 of the tray when the tray is in its resting place, since said lateral face 58 will pressure the flanges 78. Likewise, second flanges (not shown) may be provided in the cover 66, in the folding part 56 covering the outer side of the horizontal face 62 of the tray base, so that said second flanges may be folded inwardly and so that the lower face 48 of the tray may abut said second flanges. These second flanges may laterally abut the first flanges 78 above disclosed. The second flanges may be fastened with the first flanges 78 so as to provide a fastening means for the cover 66 in regards to the tray base 60.

The structure may have wheels (not shown) so that it may be easily moved. Alternately, the structure may have rubber structures (not shown) in the lower end of the lower part 22 of the column to provide a better grip with the floor; the rubber structures may be provided instead of the leg 46 or below the leg 46 of the fastening part of the lowest holding and fastening means.

In each part of the lowest part of the column 20, that is, the part which is in direct contact with the floor, which may either be the columns 20 or the legs 46 or the rubber structures or the lower part of the lowest holding and fastening means 70, at least one protuberance (not shown) which is substantially flat and may be in an inward or outward direction in regards to the exhibitor 2 may be provided. When extending the structure 2 in an upward direction, given the weight of the structure 2 and the force applied by the user to extend the telescopic column 20, the structure 2 may tend to be raised. Therefore, by providing these protuberances, the user may step on these protuberances to extend the structure 2 and forcefully extend the structure 2 without raising the structure.

Further, if the trays 68 are fastened by fastening means to the tray bases 60, the uppermost tray 68 may contain a retractable handle which may help the user to extend the structure 2. Alternately, a plurality of handles may be provided in the upper tray base 60.

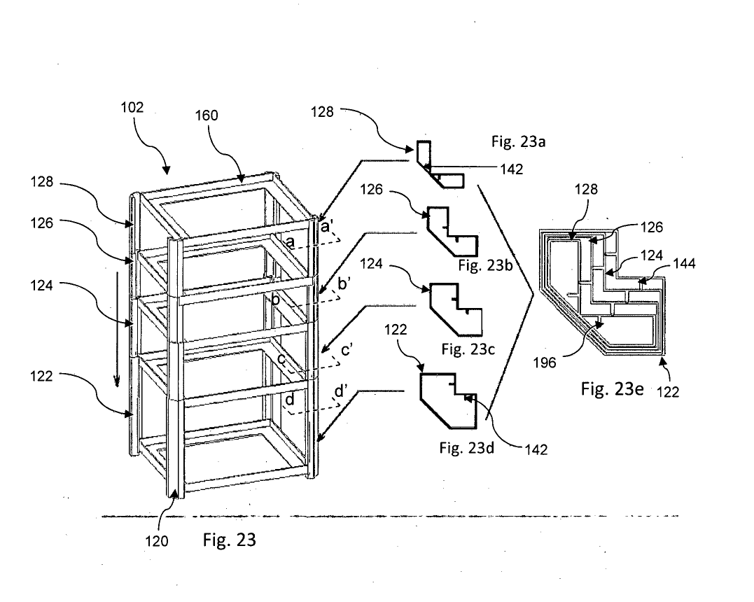

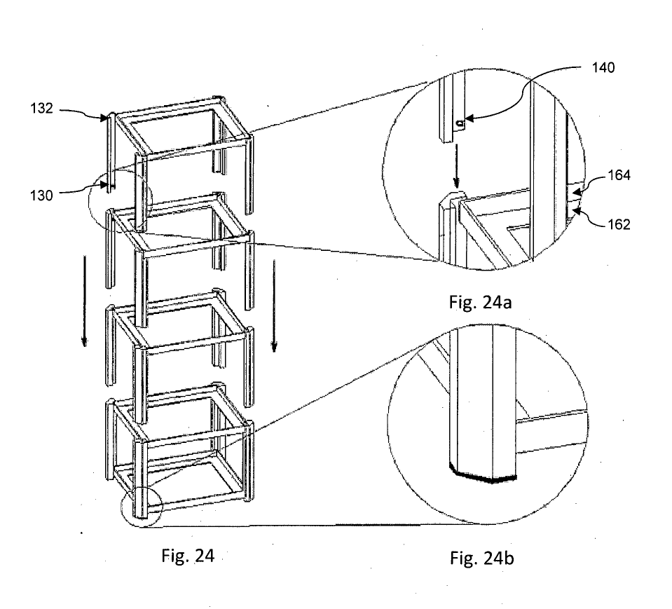

The following description is made, in reference to FIGS. 23-24b which refer to an embodiment of the invention. The figures show a telescopic display structure 102 comprising the columns 120 each column 120 having substantially hollow parts 122-128, each part 122-128 having two ends 130-132, a first part 122 having a first width and at least one groove or opening 140 proximate to the upper end 132 of said first part 122 and a second part 128 having a second width and at least one groove or opening 144 proximate to the lower end 130 of the second part, the two widths of the two parts 122-128 being different, so that at least part of the second part 128 may slide within the first part 122, the grooves or openings 140, 144 having substantially the same direction in regards to the display structure 102 and being co-lineal when the telescopic display structure 102 is in an extended position, the tray base 160 having its faces 162, 164, wherein one of the faces 162, 164 is fixed to the columns 120, more specifically, the ends of the faces 162, 164 are fixed to the column 120, and a resilient device 196 having at least two resilient parts which are substantially perpendicular between themselves, the resilient device 196 placed within the lower end 130 of the second part 128 of the columns, at least one of the two parts of the resilient device 196 has a protuberance 142 with substantially the same direction as the grooves or openings 140, 144 and with a length such that said protuberance 142 pushes or passes through the grooves or openings 140, 144 of the parts 122-128 of the column 120 when the protuberance 142 is co-lineal with said grooves or openings 140, 144 and when the telescopic display structure 102 is in an extended position. The shown collapsible product display case comprises a plurality of tray bases 160 arranged one above the other in a vertical direction, a respective plurality of column members 122-128 associated with each tray base 160 and secured in end locations of each tray base 160, each column member 122-128 having a hollow passage sized and shaped to receive therein an adjacent column member 122, 123 of an adjacent tray base 160, so that the column members 122-128 of the tray bases 160 are telescopically slidable within each other to move between a closed, collapsed state, and an extended, deployed state at which the tray bases 160 are vertically spaced from each other, a fastening mechanism 140, 142, 144, 196 associated with each tray base 160 to hold the tray bases 160 in the deployed position spaced vertically from one another; and a plurality of trays 168, each of said trays 168 being mounted in a respective one of said tray bases 160 and being configured to support thereon various products offered for sale.

Alterations in the structure just described in the present invention can be made beforehand by those with skills and art in the matter. However, it must be understood that the present description is related to the preferred modalities of the invention, which is for illustrative purposes only, and that it must not be constructed as a limitation of the invention.

1. A telescopic structure comprising:
at least three columns each having at least two substantially hollow parts, each part having two ends, a first part having a first width and at least one groove or opening proximate to an upper end and a second part having a second width and at least one groove or opening proximate to a lower end, the two widths of the two parts being different, so that at least part of the second part may slide within the first part, the grooves or openings having substantially the same direction in regards to the display structure and being co-lineal when the telescopic display structure is in an extended position;
at least one tray base having at least one face, wherein the face is fixed to the at least three columns; and
a resilient device having at least two resilient parts which are substantially perpendicular between themselves, the resilient device placed within the lower end of the second part of the columns, at least one of the two parts of the resilient device having a protuberance with substantially the same direction as the grooves or openings and with a length such that said protuberance pushes or passes through the grooves or openings of the parts of the column when the protuberance is co-lineal with said grooves or openings and when the telescopic display structure is in an extended position.

2. The telescopic display structure of claim 1, wherein the structure further comprises a tray which rests on the tray base, the at least one tray base comprises two substantially perpendicular faces, and wherein the tray base is covered by a cover, wherein the cover comprises at least four folding parts having at least two ends, one end of a first folding part having flanges, the tray when rested on the tray base fixes the cover to the tray base by means of abutting the flanges to the tray base.

3. The telescopic display structure of claim 1, wherein the structure further comprises a closure with a first and second section, the second section supporting the first section and having a width which is larger to the lower end of the second part and smaller to the upper end of the first part so that the second section abuts with the second part and slides within the first part, the first section formed by at least two walls substantially perpendicular to the second section and having generally the same direction, a first wall proximate to a first edge of the second section and a second wall proximate to a second edge of the second section, the second edge being opposite to the first edge, the first wall having a furrow in which an end of the resilient part not having the protuberance is placed, the second wall having an opening through which the protuberance of the resilient part passes through, the distance between the two walls of the first section is less than the width of the second part, so that the first section is inserted, along with the resilient device, within the lower end of the second part of the column.

4. The telescopic display structure of claim 1, wherein the structure further comprises a holding and fastening means having a fastening part and a holding part, the holding and fastening means fixed proximate to and surrounding the upper end of the first part by means of an opening in the fastening part, the holding and fastening means not obstructing the groove or opening of the first part, and the holding part being capable of fixing the face of the tray base.

5. The telescopic display structure of claim 1, wherein the at least one tray base comprises two substantially perpendicular faces, a first face being substantially vertical and a second face being substantially horizontal, and wherein the structure further comprises a holding and fastening means having a fastening part and a holding part, the holding and fastening means fixed proximate to and surrounding the upper end of the first part by means of an opening in the fastening part, the holding and fastening means not obstructing the groove or opening of the first part, and fixing the substantially vertical face of the tray base to the holding part or the fastening part of the holding and fastening means.

6. The telescopic display structure of claim 1, wherein
the at least three columns further comprise a third substantially hollow part having two ends, a third width and at least one groove or opening proximate to an upper end and at least one groove or opening proximate to a lower end, the third width being and intermediate width between the first width and the second width, so that at least a part of the third part may slide within the first part and at least a part of the second part may slide within the third part, the lower end of the third part of the columns further comprising a second resilient device having a protuberance with substantially the same direction as the grooves or openings in the lower end of the third part and with a length such that said protuberance pushes or passes through the grooves or openings of the lower end of the third part and the grooves or openings of the upper end of the first part when the protuberance is co-lineal with said grooves or openings and when said telescopic display structure is in an extended position.

7. The telescopic display structure of claim 6, wherein the structure further comprises a holding and fastening means having a fastening part and a holding part, the holding and fastening means fixed proximate to and surrounding the upper end of the first part by means of an opening in the fastening part, the holding and fastening means not obstructing the groove or opening of the first part, and the holding part being capable of fixing the face of the tray base; and
a second holding and fastening means having a fastening part and a holding part, the holding and fastening means fixed proximate to and surrounding the upper end of the third part by means of an opening in the fastening part, the holding and fastening means not obstructing the groove or opening of the third part, and the holding part being capable of fixing the face of the tray base.

8. The telescopic display structure of claim 1, wherein the first part of the at least three columns is in a lower part than the second part of the at least three columns.

9. The telescopic display structure of claim 8, wherein the first part of a first column contains a plurality of grooves or openings throughout the vertical height of said first part and wherein the first part of a second column contains a plurality of grooves or openings throughout the vertical height of said first part which are not co-lineal with the plurality of grooves or openings throughout the vertical height of the first part of the first column, so that when the tray base is fixed to the columns through said at least one face, the tray base is in a slanted position.

10. The telescopic display structure of claim 4, wherein the structure further comprises a tray which rests on the tray base, the at least one tray base comprises two substantially perpendicular faces, and wherein the tray base is covered by a cover, wherein the cover comprises at least four folding parts having at least two ends, one end of a first folding part having flanges, the tray when rested on the tray base fixes the cover to the tray base by means of abutting the flanges to the tray base,
wherein the fastening part further comprises at least two substantially perpendicular walls that abut the holding part,
wherein when the tray base is placed in its resting position, a vertex of the tray base will be proximate or abutting said substantially perpendicular walls.

11. The telescopic display structure of claim 10, wherein fastening means hold together the tray base by the horizontal face of the tray base and the substantially perpendicular walls of the fastening part of the holding and fastening device.

12. The telescopic display structure of claim 1, wherein the structure further comprises a holding and fastening means having a fastening part and a holding part, the holding and fastening means fixed proximate to and surrounding the lower end of the first part by means of an opening in the fastening part and the holding part being capable of fixing the face of the tray base;
wherein in the lower part of the fastening part of the holding and fastening means, a leg is provided to leave a space between the floor and the exhibitor.

13. The telescopic display structure of claim 1, wherein the first part of the at least three columns is in a lower position and the second part of the at least three columns is in an upper position, the second part further comprising at least a second groove or opening proximate to the upper end with substantially the same direction than the groove or opening in the lower end of the second part, the structure further comprises
a publicity top having at least one hollow post having at least one groove or opening proximate to its lower end and a resilient device within said hollow post, wherein the publicity top is fastened to at least one of the columns by means of the protuberance of the resilient device within the hollow post, the groove or opening proximate to the lower end of the hollow post and the second groove or opening in the upper end of the second part.

14. The telescopic display structure of claim 13, wherein the display structure further comprises two holding and fastening means having a fastening part and a holding part,
a first the holding and fastening means fixed proximate to and surrounding the upper end of the second part of each of the columns by means of an opening in the fastening part, the holding and fastening means not obstructing the second groove or opening; and
a second the holding and fastening means fixed proximate to and surrounding the upper end of the first part of each of the columns by means of an opening in the fastening part, the holding and fastening means not obstructing the groove or opening in the upper end of the first part.

15. The telescopic display structure of claim 1, wherein in lowest part of the column, the display structure further comprises at least one substantially flat protuberance in contact with the floor.

16. The telescopic display structure of claim 1, wherein in an upper part of the structure at least one handle is provided.

17. A collapsible product display case, comprising:
a plurality of tray bases arranged one above the other in a vertical direction;
a respective plurality of column members associated with each tray base and each tray base secured to the plurality of column members, each column member having a hollow passage sized and shaped to receive therein an adjacent column member of an adjacent tray base, so that the column members of the tray bases are telescopically slidable within each other to move between a closed, collapsed state, and an extended, deployed state at which the tray bases are vertically spaced from each other;
a fastening mechanism comprising a protuberance associated with a higher column member which is interlockably engageable with a corresponding opening in an adjacent lower column member, to maintain the extended deployed state; and
a plurality of trays, each of said trays being mounted in a respective one of said tray bases and being configured to support thereon various products offered for sale.

18. (canceled)

19. The collapsible product display case of claim 17, wherein the protuberance is resiliently biased to engage the corresponding opening.

20. The collapsible product display case of claim 17, wherein each tray base is four-sided to define four corners, and each corner is provided with a holding device which holds and supports an associated one of said column members.

21. The collapsible product display case of claim 17, wherein the tray bases and the column members are formed of cardboard material.

22. The collapsible product display case of claim 17, further including an outer, decorated cover which is configured to be slipped over the product display case when it is in the deployed state, the decorated case being imprinted with decorative and informational text.
